(19) United States
(12) Patent Application Publication
(10) Pub. No.: US 2014/0316914 A1
(43) Pub. Date: Oct. 23, 2014

(54) Chefteria System And Method

(71) Applicant: Purna Chander Ramini, Bentonville, AR (US)

(72) Inventor: Purna Chander Ramini, Bentonville, AR (US)

(21) Appl. No.: 14/211,277

(22) Filed: Mar. 14, 2014

Related U.S. Application Data
(60) Provisional application No. 61/802,451, filed on Mar. 16, 2013.

(51) Int. Cl. G06Q 30/06; H04L 29/06; G06Q 50/12

(52) U.S. Cl. CPC G06Q 30/0621; G06Q 50/12; H04L 65/60
USPC 705/15; 709/217

(57) ABSTRACT

Chefteria System And Method provides web based computer system/platform for the chefs to create and sell their menu of freshly prepared-to-the-order foods and deliver instantly to the customers. Registered customers who place the successful food order through online system can view the live video streaming of the chefs preparation/cooking of their order. Registered chefs who are approved through selection process, only will be able to sell their foods through Chefteria platform. Chefs in this system can specify location(s)/day(s)/time(s) information that they would like to offer their services.

### BACKGROUND

There are lot of food joint places that provide dine-in/carry-out/delivery services but very rarely a healthy gourmet foods, available for the delivery that are prepared by trained and passionate chefs who use fresh ingredients.

### SUMMARY

Cheferia System And Method provides Web based computer platform where chefs can offer their food services. Chefs who intend to offer their services will register first where they go through selection process based on set criteria. Upon successful passing of selection criteria, chefs will be allowed to create their menu and sell food. Chefs also can create possible selection options that their customers can use to order food to their taste and preferences. Chefs can specify the location(s) they like to serve, days and times they like to offer their foods. Customers who like to order foods should be registered. During the chefs preparation and cooking, customers who placed successful online orders for foods from this particular chef can see live video streaming. Freshly made-to-order foods are arranged for the delivery by the respective chefs.

### GENERAL DESCRIPTION OF DRAWINGS

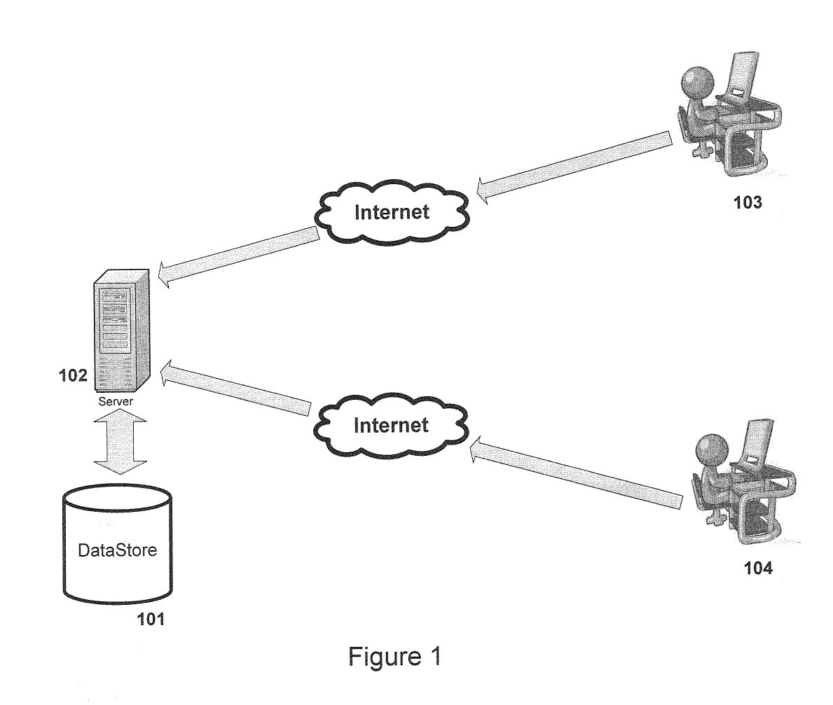

In FIG. 1, item 101 is DataStore, that stores registered customers information, registered chefs information, their menu details and customer order details.

In FIG. 1, item 102 is the web based computer system/platform that manages chefs registration, their menus, their menu preferences/options for customers, customers registration, live video streaming, customer orders and payment information.

In FIG. 1, item 103 is chef using web enabled device in registering, creating menu, number of orders he can serve on given day/time and the locations he/she can serve.

In FIG. 1, item 104 is customer using web enabled device in registering and ordering food.

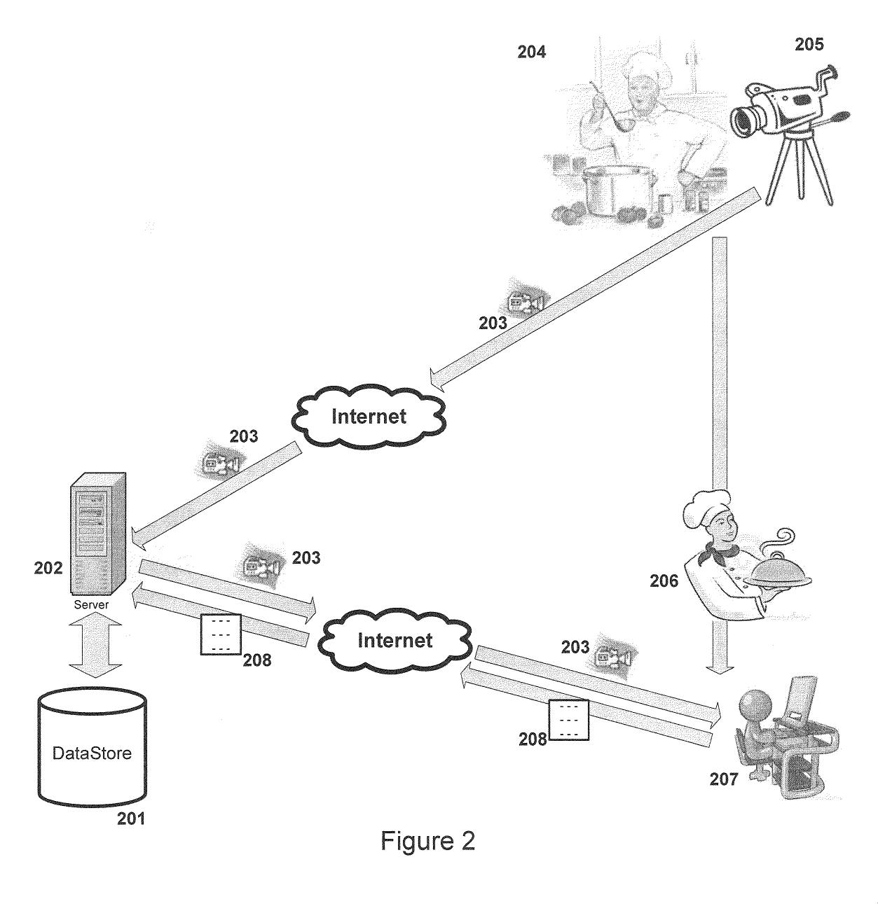

In FIG. 2, items 201 & 202 are same as items 101 & 102 in FIG. 1 respectively.

In FIG. 2, item 203 is live video streaming feed that is carried from chefs kitchen to the customer's web enabled device.

In FIG. 2, item 204 is the chef's kitchen where made-to-order food is prepared/cooked for the customers.

In FIG. 2, item 205 is a video camera that is capturing the live and action and creating the live feed to his/her customers.

in FIG. 2, item 206 is showing the made-to-order food is being delivered instantly.

In FIG. 2, item 207 is showing the customer who is watching the live video streaming from the chefs kitchen where he/she order the food.

In FIG. 2, item 208 is showing the optional feed back customer is providing to the chef on his preparation/cooking for his review at the later time.

### GENERAL DESCRIPTION OF EMBODIMENTS

In FIG. 1 is showing the chef registering on the chefteria platform. Once he/she passes the selection process, he/she can create a menu and start selling their foods. It also showing the customer who is registering and placing order for food using web enabled device.

In FIG. 2 is showing the food being prepared by the chef in his/her kitchen while live video streaming is made available to the customers who ordered the food from that particular chef on this day/time. This picture is also showing a customer who is watching the live video streaming of the chefs preparation/cooking. This figure also shows that the prepared/cooked food is delivered instantly to the customer(s) who ordered the food from this particular chef.

1. Providing online platform for the independent chefs to sell their gourmet foods for instant delivery is unique.

2. Providing live video streaming of the food preparation/cooking from the chef's kitchen to his/her customers through web enabled device is unique.

3. Providing made-to-order gourmet option for freshly prepared/cooked food to the customers online is unique.
